(19) United States
(12) Patent Application Publication
(10) Pub. No.: US 2026/0081892 A1
(43) Pub. Date: Mar. 19, 2026

(54) FAKE E-SHOP DETECTION

(71) Applicant: UAB 360 IT, Vilnius (LT)

(72) Inventors: Mantas BRILIAUSKAS, Vilnius (LT); Vykintas MAKNICKAS, Vilnius (LT); Artur LAGUTIN, Vilnius (LT)

(21) Appl. No.: 19/396,855

(22) Filed: Nov. 21, 2025

Related U.S. Application Data
(63) Continuation-in-part of application No. 18/417,367, filed on Jan. 19, 2024, now Pat. No. 12,483,531.
Application No. 18/417,367 is a continuation-in-part of application No. 17/948,857, filed on Sep. 20, 2022, now Pat. No. 11,916,875.
Application No. 17/948,857 is a continuation of application No. 17/545,479, filed on Dec. 8, 2021, now Pat. No. 11,470,044.

(51) Int. Cl. H04L 9/40; G06N 20/00

(52) U.S. Cl. CPC H04L 63/0236; G06N 20/00; H04L 63/0263; H04L 63/1416

(57) ABSTRACT

A method, apparatus, and system for website filtering includes a processor and a memory having stored therein at least programs or instructions executable by the processor to cause the system to load HTML content of a requested website, extract website indicators from the loaded HTML content, perform feature engineering on the extracted website indicators, filter the website by applying a machine learning model trained to analyze the engineered website indicators to predict whether a resource of the website is associated with a fake e-shop, and if it is determined that a resource of the requested website is associated with a fake e-shop, generate and transmit a website filter determination that the resource of the website is associated with a fake e-shop.

### CROSS-REFERENCE TO RELATED APPLICATIONS

This application is a Continuation-in-part of and claims benefit of and priority to U.S. patent application Ser. No. 18/417,367, filed Jan. 19, 2024, which is a Continuation-in-Part of and claims benefit of and priority to U.S. patent application Ser. No. 17/948,857, filed Sep. 20, 2022, now U.S. Pat. No. 11,916,875 issued on Feb. 27, 2024, which is a Continuation of and claims benefit of and priority to U.S. patent application Ser. No. 17/545,479 filed Dec. 8, 2021, now U.S. Pat. No. 11,470,044 issued on Oct. 11, 2022, which are all herein incorporated by reference in their entireties.

### FIELD

This disclosure relates generally to computer security, and more particularly to identifying fake e-shops.

### BACKGROUND

Fake e-shops are fraudulent online stores that appear legitimate but are designed to deceive customers. They often mimic real brands, use convincing product images, and offer unusually low prices to lure buyers. Once a customer places an order, several outcomes are possible: the purchased product never arrives, a counterfeit or inferior item is delivered, or the buyer's payment and personal data are stolen for further exploitation. As a result of fake e-shops, consumers lose money, face identity theft, and struggle to get refunds. In addition, legitimate businesses suffer from brand damage, lost sales, and reduced customer trust. Currently, there are no solutions to reliably detect fake e-shops.

### SUMMARY

Methods, apparatuses, and systems for fake e-shop detection are provided herein.

In one embodiment, a method for website filtering includes a processor and a memory having stored therein at least programs or instructions executable by the processor to cause the system to load HTML content of a requested website, extract website indicators from the loaded HTML content, perform feature engineering on the extracted website indicators, filter the website by applying a machine learning model trained to analyze the website indicators to predict whether a resource of the website is associated with a fake e-shop, and if it is determined that a resource of the requested website is associated with a fake e-shop, generate and transmit a website filter determination that the resource of the website is associated with a fake e-shop.

In one embodiment, a system for website filtering includes a hardware processor, and a memory accessible by the processor, the memory having stored therein at least one of programs or instructions. In some embodiments, when the program and instructions are executed by the at least one processor the filtering system is configured to perform operations including receiving a request to access a resource associated with a website, loading HTML content of the requested website, extracting website indicators from the loaded HTML content, applying feature engineering on the extracted website indicators, filtering the website by applying a machine learning model trained to analyze the website indicators to predict whether a resource of the website is associated with a fake e-shop, and, if it is determined that a resource of the requested website is associated with a fake e-shop, generating and transmitting a website filter determination that the resource of the website is associated with a fake e-shop.

In one embodiment, a non-transitory computer readable medium, which when executed by a processor and a memory, performs a website filtering method including receiving a request to access a resource associated with a website, loading HTML content of the requested website, extracting website indicators from the loaded HTML content, performing feature engineering on the extracted website indicators, filtering the website by applying a machine learning model trained to analyze the website indicators to predict whether a resource of the website is associated with a fake e-shop, and if it is determined that a resource of the requested website is associated with a fake e-shop, generating and transmitting a website filter determination that the resource of the website is associated with a fake e-shop.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of a network architecture of a system for fake e-shop detection in accordance with an embodiment of the present principles.

FIG. 2 depicts a flow diagram of a method for fake e-shop detection, in accordance with an embodiment of the present principles.

FIG. 3 depicts a flow diagram of a method for fake e-shop detection, in accordance with an alternate embodiment of the present principles

FIG. 4 depicts a flow diagram of an example of a sub-process of the method of FIG. 3 for predicting whether the requested website is a fake e-shop in accordance with at least one embodiment of the present principles.

FIG. 5 depicts a computer system that can be utilized to implement the various embodiments of the present principles in accordance with at least one embodiment.

FIG. 6 depicts a flow diagram of a method for website filtering in accordance with an alternate embodiment of the present principles.

FIG. 7 depicts a flow diagram of a method 700 for website filtering in accordance with an embodiment of the present principles.

To facilitate understanding, identical reference numerals have been used, where possible, to designate identical elements that are common to the FIG.s. The FIG.s are not drawn to scale and may be simplified for clarity. It is contemplated that elements and features of one embodiment may be beneficially incorporated in other embodiments without further recitation.

### DETAILED DESCRIPTION

The following detailed description describes techniques (e.g., methods, apparatuses, and systems) for fake e-shop detection. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

Embodiments consistent with the present principles implement a solution that can be applied on websites requested by user devices to detect fake e-shops. In some embodiments, the fake e-shops are identified using, what the inventors refer to as, indicators. That is, in some embodiments when a user opens a website, the website is scanned for indicators. These indicators come from patterns recognized in previously known fake e-shop websites.

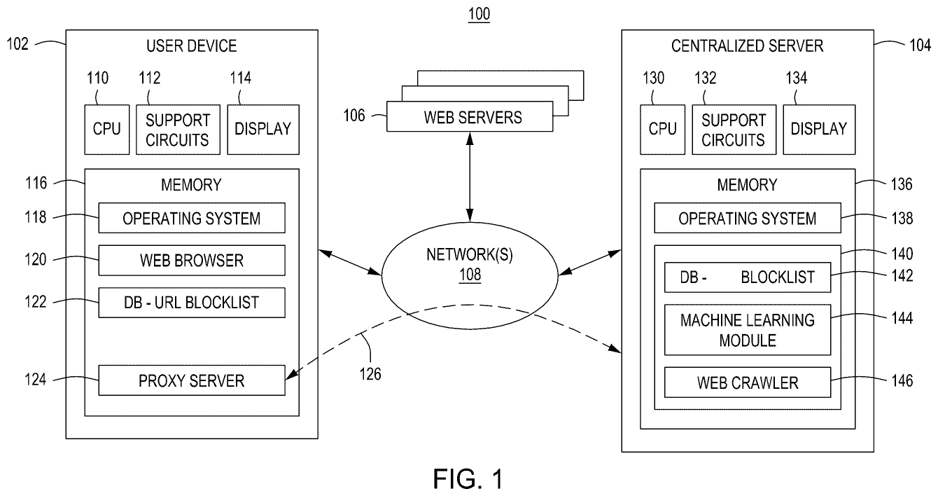

FIG. 1 depicts a high-level block diagram of a network architecture of a system for fake e-shop detection in accordance with an embodiment of the present principles. The system 100 of FIG. 1 includes one or more user devices 102, a centralized server 102, and web servers 106 communicatively coupled via one or more networks 108.

In the embodiment of FIG. 1, the networks 106 comprise one or more communication systems that connect computers by wire, cable, fiber optic and/or wireless link facilitated by various types of well-known network elements, such as hubs, switches, routers, and the like. The networks 106 can include an Internet Protocol (IP) network, a public switched telephone network (PSTN), or other mobile communication networks, and can implement various well-known protocols to communicate information amongst the network resources.

In the embodiment of FIG. 1, the end-user device 102 comprises a Central Processing Unit (CPU) 110, support circuits 112, display device 114, and memory 116. The CPU 110 can comprise one or more commercially available microprocessors or microcontrollers that facilitate data processing and storage. The various support circuits 112 facilitate the operation of the CPU 110 and include one or more clock circuits, power supplies, cache, input/output circuits, and the like. The memory 116 of the embodiment of FIG. 1 can comprises at least one of Read Only Memory (ROM), Random Access Memory (RAM), disk drive storage, optical storage, removable storage and/or the like. In some embodiments, the memory 116 can comprise an operating system 118, web browser 120, a fake e-shop indicators list 122 in the form of a database, file or other storage structure, and a transparent proxy server 124.

In the embodiment of FIG. 1, the operating system (OS) 118 generally manages various computer resources (e.g., network resources, file processors, and/or the like). The operating system 118 is configured to execute operations on one or more hardware and/or software modules, such as Network Interface Cards (NICs), hard disks, virtualization layers, firewalls and/or the like. Examples of the operating system 118 can include, but are not limited to, various versions of LINUX, MAC OSX, BSD, UNIX, MICROSOFT WINDOWS, IOS, ANDROID and the like.

In the system 100 of FIG. 1, the web browser 120 is a well-known application for accessing and displaying web page content. Such browsers include, but are not limited to, Safari®, Chrome®, Explorer®, Firefox®, etc. In some embodiments of the system 100 of FIG. 1, an optional fake e-shop indicators list 122 (described in greater detail below) is included, which comprises a list of indicators identified in fake e-shop that are stored in the form of a database, file or other storage structure or format that is accessible to the web browser 120 and proxy server 124.

In some embodiments, the transparent proxy server 124 of the present principles can be a security service that runs on the user device 102 in the background. For example, for every website request generated by the web browser 120, the proxy server 124 can intercept the website request and forward website indicators of the requested website, determined in accordance with embodiments of the present principles, to the centralized server 104 (e.g., via communication 126) to check whether the website is associated with a fake e-shop. If the centralized server 104 determines that website is not associated with a fake e-shop, the transparent proxy server 124 can allow the web browser 120 to establish the connection with the requested website (e.g., web server 106). If the centralized server 104 determines that the website is associated with a fake e-shop, the transparent proxy server 124 can block the connection. In some embodiments, if the website is determined to be associated with a fake e-shop, the proxy server 124 or the web browser 120 can generate a notification (e.g., a warning message) to display on the user device 102 to inform a user of a reason why access to the requested website is being denied. In some embodiments, the denial of access to the website can be overridden by a user selection through interaction with the web browser 120 or other interface displayed by the proxy server 124 (i.e., by entering an override command into the web browser 120 or the proxy server 124).

In the embodiment of FIG. 1, the centralized server 104 of the system 100 comprises a Central Processing Unit (CPU) 130, support circuits 132, display device 134, and memory 136. The CPU 130 can comprise one or more commercially available microprocessors or microcontrollers that facilitate data processing and storage. The various support circuits 132 facilitate the operation of the CPU 130 and include one or more clock circuits, power supplies, cache, input/output circuits, and the like. The memory 136 comprises at least one of Read Only Memory (ROM), Random Access Memory (RAM), disk drive storage, optical storage, removable storage and/or the like. In some embodiments, the memory 136 comprises an operating system 138 and a website verification module. The website verification module 140 can include a website/indicator blocklist 142 in the form of a database, file or other storage structure, a machine learning module 144, and a web crawler 146. In some embodiments, at least one of the blocklist 142, the machine learning module 144, or the web crawler 146 can reside on the proxy server 124 to reduce any latency caused by communication between the centralized server 104 and the proxy server 124 over the communication network 108.

In some embodiments of the present principles and as described above, when a user device 102 generates a request for a website, the transparent proxy server 124 running on the user device 102 will send the website request to the centralized server 104 for processing. The request can be sent as a request for verification to determine if the website is associated with a fake e-shop. The website verification module 140 will process the website verification request through one or more layers of website filtering process of the present principles as described herein.

For example, in some embodiments when a website is requested, as a first layer of a website filtering process of the present principles, the website verification module 140 can first load the requested website. That is, in some embodiments the website verification module 140 loads the website and if the website responds successfully, for example with a 200 status code, the HTML content can be extracted. The content is then analyzed to determine if the content contains any indicators indicating that the website is associated with a fake e-shop. In some embodiments, indicators of the present principles can be categorized into 3 types:
a. External indicators—data like WHOIS info, certificates, and other general site data;
b. HTML indicators-pulled straight from the website's HTML code;
c. LLM indicators—these rely on language models to figure things out by analyzing extracted website's HTML content.

In some embodiments of the present principles, external indicators are used to assess the technical trustworthiness and risk profile of a domain. In some embodiments, the trustworthiness determination can be determined based on scripts including but not limited to: cert_is_valid, cert_issuer, cisco_rank, domain_age_days, registrant_is_private, is_isp_safe, and the like.

In some embodiments of the present principles, the HTML indicators can include specific elements or patterns within a web page's HTML code that provide information about the structure, content, or functionality of the site. In accordance with the present principles, by extracting and analyzing these HTML indicators, it is possible to gain insights into the website's purpose, trustworthiness, and user experience. Some HTML indicators can include but are not limited to title_elements, telephone numbers, email addresses and messenger information, fuzzy_sim, unusual_chaacters, mobile_apps, social_media_deep_links, social_media_sharer_links, review_platform_links, iframes_count, html_payment_systems and the like.

In some instances, certain indicators cannot be extracted directly from HTML tags because they rely on natural language interpretation. In such embodiments, the internal knowledge base of an LLM of the present principles is used to make a determination regarding the identified indicators. For example, an LLM of the present principles can use the following scripts to determine if indicators exist that identify a website as a fake e-shop: scam_marketing_score, contains_too_good_to_be_true_phrases, contains_unusual_sense_of_urgency_phrases, contains_bad_grammar, contains_illegal_content, contains_pornography_content, contains_fake_looking_reviews, sells_counterfeit_products, is_under_construction, price_repetition, and the like.

In embodiments of the present principles, the extracted website content (e.g., the indicators) is then analyzed by, for example, the website verification module 140, to determine if the extracted website is associated with a fake e-shop. In some embodiments, to analyze the extracted website content, the website verification module 140 can perform a feature engineering process to filter the identified features of extraneous information enabling better analysis of the identified indicators. For example, in some embodiments, the feature engineering process can include, but is not limited to at least a Handling Missing Values process and a Feature Conversion & Aggregation process, which can include at least a Certificate Extraction process, a Combining Boolean Values process, and a Data Type Handling process.

In the Handling Missing Values process, all types of missing data from a previous step (None, np.nan, nan) are standardized to pd.NaN for consistency. The Feature Conversion & Aggregation process focuses on transforming indicators from a previous step into a standardized format, or extracting specifics, so the final list can be used for model prediction. Specifically, in the Certificate Extraction process of the Feature Conversion & Aggregation process only key values from SSL certificates indicator are kept: cert_issuer C, cert_issuer CN, cert_issuer O. In some embodiments, extracted certificate values are converted to lowercase for consistency.

In some embodiments, in the Combining Boolean Values process of the Feature Conversion & Aggregation process, email addresses and phone numbers can be extracted both through static functions from HTML indicators and with the help of an LLM. As such, indicators with equivalent meaning present in both HTML and LLM outputs (e.g., email_from_HTML+email_from_LLM, phone_number_from_HTML+phone_number_from_LLM) are aggregated into single features (email_from_HTML_email_from_LLM, phone_number_from_HTML_phone_number_from_LLM). In some embodiments, the logic applied can proceed as follows: True if either one of the value is true, NA if both are NA, and False otherwise.

In some embodiments, the Data Type Handling process of the Feature Conversion & Aggregation process can include Numerical Data processing and Boolean Data processing. The Numerical Data processing can include columns containing numbers and is formatted as numeric. The Boolean Data processing includes columns that represent a potential “yes/no” state, whether originating from HTML indicators or LLM indicators (in the form of strings, lists, or dictionaries), are normalized into standard Boolean values: True or False.

In the system 100 of FIG. 1, the engineered indicators can be communicated to the machine learning module 144. That is, in some embodiments of the present principles the centralized server 104 can implement the machine learning module 144 to predict whether or not indicator(s) determined from the requested website in accordance with the present principles identify the requested website as a fake e-shop. In such embodiments, if the requested website is predicted to be a fake e-shop by the machine learning module 144, the centralized server 104 can generate a response to the proxy server 124 (e.g., a website filter determination) including a notification that the website is a fake e-shop.

In some embodiments, machine learning algorithms implemented by the machine learning module 144 can include a multi-layer neural network comprising nodes that are trained to have specific weights and biases. In some embodiments, the machine learning algorithm can implement artificial intelligence techniques or machine learning techniques to determine if websites are fake e-shops based on containing specific indicators, which can exhibit predictable patterns. In some embodiments, in accordance with the present principles, suitable machine learning techniques can be applied to learn commonalities in indicators of websites that are fake e-shops and for determining from the machine learning techniques at what level indicators of websites that are fake e-shops can be canonicalized. In some embodiments, machine learning techniques that can be applied to learn commonalities in indicators of websites that are fake e-shops can include, but are not limited to, regression methods, ensemble methods, or neural networks and deep learning such as ‘Seq2Seq’ Recurrent Neural Network (RNNs)/Long Short Term Memory (LSTM) networks, Convolution Neural Networks (CNNs), Encoders and/or Decoders (including Transformers), graph neural networks applied to the abstract syntax trees corresponding to the indicators of websites that are fake e-shops, and the like.

In some embodiments, the machine learning module 144 can train a machine learning model of the present principles using a plurality (e.g., hundreds, thousands, millions, etc.) of instances of labeled data including indicators of the present principles existent in fake e-shop websites. For example, in some embodiments, a machine learning model can be trained to recognize if a website comprises a fake e-shop by analyzing individual indicators present in a website based on individual indicators present in fake e-shops used to train the machine learning model. In such embodiments, individual indicators can be weighted differently based on how likely a website is to be a fake e-shop if that individual indicator is present in a website. Alternatively or in addition, in some embodiments it is the existence of combinations of indicators that can be used to determine if a website is a fake e-shop. For example, in some embodiments of the present principles, all indicators, HTML, LLM, and External, can be combined/aggregated into a single feature vector for communication to the machine learning module 144 at which the vector is used by the machine learning model of the learning module 144 to determine if a requested website is a fake e-shop. In accordance with the present principles, a machine learning model is trained to determine from identified indicators of a requested website if the requested website is a fake e-shop. In some embodiments, a machine learning model of the present principles is trained using both positive negative examples of indicators that exist and do not exist in fake e-shops to more thoroughly train a machine learning model of the present principles to identify requested websites that are fake e-shops based on indicators identified in requested websites. That is, based on indicators of websites that are fake e-shops as well as indicators of websites that are known to be good websites, the machine learning module 144 can train a machine learning model of the present principles to identify websites that are fake e-shops. In some embodiments, the machine learning model can be trained under the assumption that fake e-shop websites are often generated in predictable patterns. For example, a machine learning model of the present principles can be trained that a website containing related indicators is not a fake e-shop or, alternatively can indicate that a website is a fake e-shop. In such embodiments, the machine learning model/module 144 can check if indicators in the requested website are related to, or are likely to be next to, each other. As another example, a machine learning model of the present principles can be trained that websites that contain indicators in proper context are less likely to be a fake e-shop. In such embodiments, the machine learning model/module 144 can employ natural language processing (NLP) to analyze a website contextually.

In some embodiments, the machine learning model/module 144 of the present principles, in determining if a website is a fake e-shop can generate a score based on the determined/identified indicators of a website. The determined score can be compared to a settable threshold to determine whether or not the website is a fake e-shop. For example, in some embodiments, if the score is at or above the threshold, the requested website may be determined to be a fake e-shop, while a score below the threshold may indicate that the website is not a fake e-shop. In other embodiments, two thresholds—a lower and an upper—can be used. For example, if the score is below the lower threshold, the website can be determined as not being a fake e-shop, while if the score is above the upper threshold, the website can be determined as being a fake e-shop. Moreover, if the score is between the upper and lower thresholds, the website can be determined as potentially a fake e-shop (some similar websites to the requested website were fake e-shops (were associated with fake e-shops), and some similar websites to requested one were not fake e-shops (were not associated with fake e-shops).

In some embodiments, the centralized server 104 can be configured to send a response (e.g., website filter determination) to the proxy server 124 based on a determination made by the machine learning model/module 144. That is, based on the determination made by the machine learning model/module 144, the proxy server 124 can be permitted or restricted from accessing a requested website.

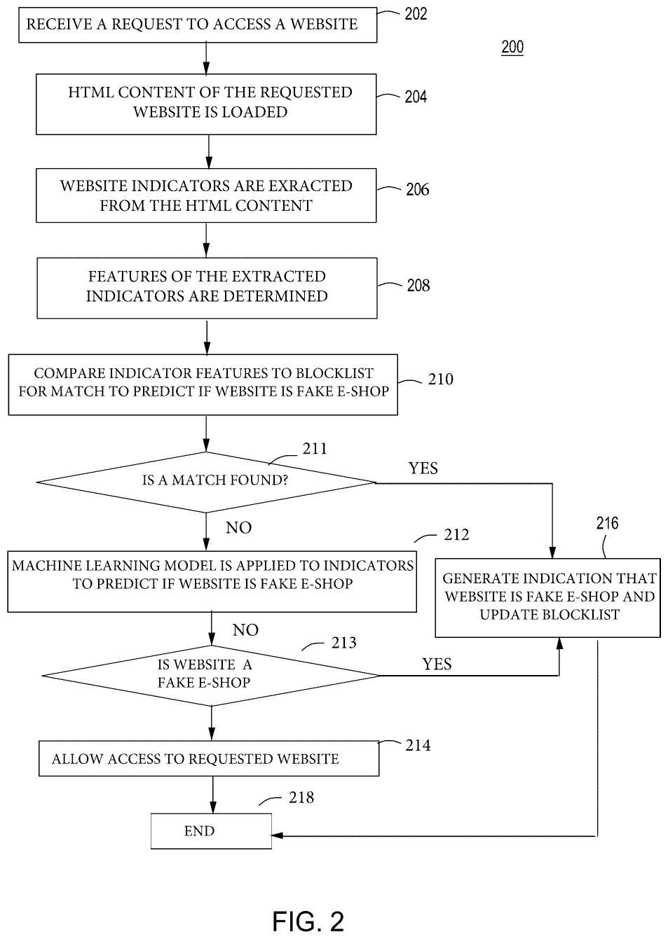

FIG. 2 depicts a flow diagram of a method 200 for fake e-shop detection, in accordance with an embodiment of the present principles. The method 200 can begin at 202 during which a request for a website can be received. For example and as described above, in some embodiments, the centralized server 104 can receive a website request from the user device 102 through the communication network 108. The method 200 can proceed to 204.

At 204, HTML content of the requested website is loaded. The method 200 can proceed to 206.

At 206, website indicators are extracted from the loaded HTML content. As depicted in FIG. 2 and as described above, in some embodiments website indicators can include External indicators 206₁, HTML indicators 206₂, and LLM indicators 206₃. The method 200 can proceed to 208.

At 208, Feature Engineering is performed on the extracted website indicators. As depicted in FIG. 2 and as described above, in some embodiments the Feature Engineering is implemented to condition the extracted website indicators for processing by the machine learning model/module 144 and can include a Handling missing values (HMV) process 208₁ and a Feature conversion and aggregation (FCA) process 208₂. The method 200 can proceed to 210.

At 210, a machine learning model trained to analyze the website indicators to predict whether a resource of the website is associated with a fake e-shop is applied to the engineered, extracted website indicators to predict if the requested website, associated with the engineered, extracted website indicators, is a fake e-shop. The method 200 can then proceed to 212.

At 212, if the requested website is identified as a fake e-shop, the method 200 can proceed to 214. If the requested website is not identified as a fake e-shop, the method 200 can proceed to 216.

At 214, at least one of, a message is communicated to a user, that requested the website, identifying the website as a fake e-shop and/or access to the requested website can be blocked. The method 200 can end at 218.

At 216, at least one of, a message is communicated to a user, that requested the website, identifying the website as not a fake e-shop or a user that requested the website is given access to the requested website. The method 200 can end at 218.

In some embodiments the method can further include filtering the website by comparing the features of the extracted website indicators to a blocklist of website indicators identified as being associated with at least one fake e-shop to predict if a resource of the website is associated with a fake e-shop and if it is determined that a resource of the requested website is associated with a fake e-shop, updating the blocklist to include an identification of at least one of the extracted website indicators or the requested website.

In some embodiments, the method includes comparing the features of the extracted website indicators to a blocklist of website indicators to predict if a resource of the website is associated with a fake e-shop according to predetermined blocklist rules.

In some embodiments, the method includes, if it is determined that a resource of the website is not associated with a fake e-shop, filtering the website by comparing at least one visual feature of the resource associated with the website with at least one respective visual feature of a known legitimate website to identify similarities and/or differences to determine if the resource associated with the website is associated with a fake e-shop.

In some embodiments, the method further includes identifying similarities and/or differences between the at least one visual feature of a resource of the requested website and the at least one respective visual feature of the known legitimate website using a machine learning model trained to determine if a resource of the website is associated with a fake e-shop.

In some embodiments, the website indicators comprise patterns identified in previously known fake e-shop websites. In such embodiments, the website indicators comprise at least one of external indicators, HTML indicators, or large learning model (LLM)-determined indicators.

In some embodiments, a website filtering system includes a hardware processor, and a memory accessible by the processor, the memory having stored therein at least one of programs or instructions. In some embodiments, when the program and instructions are executed by the at least one processor the filtering system is configured to perform operations including receiving a request to access a resource associated with a website, loading HTML content of the requested website, extracting website indicators from the loaded HTML content, applying feature engineering on the extracted website indicators, filtering the website by applying a machine learning model trained to analyze the website indicators to predict whether a resource of the website is associated with a fake e-shop, and, if it is determined that a resource of the requested website is associated with a fake e-shop, generating and transmitting a website filter determination that the resource of the website is associated with a fake e-shop.

In some embodiments, a non-transitory computer readable medium, which when executed by a processor and a memory, performs a website filtering method including receiving a request to access a resource associated with a website, loading HTML content of the requested website, extracting website indicators from the loaded HTML content, performing feature engineering on the extracted website indicators, filtering the website by applying a machine learning model trained to analyze the website indicators to predict whether a resource of the website is associated with a fake e-shop, and if it is determined that a resource of the requested website is associated with a fake e-shop, generating and transmitting a website filter determination that the resource of the website is associated with a fake e-shop.

As described above, in some embodiments, a system of the present principles, such as the system 100 of FIG. 1, can include an optional fake e-shop indicators list 122. In such embodiments in which the optional fake e-shop indicators list 122 is implemented, for every website request generated by the web browser 120, the web browser 120 will first check the requested website indicators against a locally stored fake e-shop indicator list 122. If the locally stored fake e-shop indicator list 122 contains any identified indicators of the requested website, the requested website can be identified as a fake e-shop and the web browser 120 can deny access to the website requested. Alternatively or in addition, In some embodiments, the proxy server 124 can also add any websites and/or indicators determined by the centralized server 104 to be associated with a fake e-shop to a local website and/or indicator blocklist 122 stored in a storage device accessible to the user device 102. That is, the proxy server 124 can receive a list or a number of websites and/or indicators determined to be associated with fake e-shops (e.g., 10s, 100s, or 1000s of websites and/or indicators determined to be associated with fake e-shops) determined by the centralized server 104 and update or replace the local blocklist 122 accordingly.

In some embodiments, the verification module 140 can determine/identify indicators in a requested website in accordance with the present principles and as described above. The indicator(s) determined by, for example, the verification module 140 can be compared to websites/indicators stored in the website/indicator blocklist 142 to determine if the determined indicator(s) is listed in the website/indicator blocklist 142. That is, in accordance with embodiments of the present principles, the centralized server 104 can receive a website request and compares the website indicator(s) determined by, for example, the verification module 140 (as described above), with the indicators in the website/indicator blocklist 142 identified as indicators in known fake e-shops to determine whether or not the determined indicator(s) of the requested website matches at least one indicator listed in the website/indicator blocklist 142. If the determined indicator(s) of the requested website matches an indicator in the website/indicator blocklist 142, then the centralized server 104 can generate a response (e.g., a website filter determination) to the proxy server 124 on the user device 102 including a notification that the requested website is a fake e-shop. In such embodiments, the website requested by the user can then be added to/listed in the website/indicator blocklist 142 as a fake e-shop.

In some embodiments, the process of comparing determined/identified indicators to a blocklist of the present principles can be performed by the machine learning model/module 144. In such embodiments, the machine learning model/module 144 can determine blocklist rules for performing such a process. In some embodiments, the blocklist rules can be derived from an analysis of the website/indicator blocklist 142. For example, the machine learning module 144 can train a machine learning model to derive blocklist rules based on indicators of websites that are fake e-shops that are listed in the website/indicator blocklist 142 as well as indicators of websites that are known to be good websites. Thus, the machine learning module 144 can implement the website/indicator blocklist 142 and a list of indicators of good websites to train the machine learning model to generate the website/indicator blocklist rules. In some embodiments, the machine learning model can be trained under the assumption that fake e-shop websites are often generated in predictable patterns. For example, one blocklist rule that can be generated from the machine learning model is that a website containing related indicators can indicate the website is not a fake e-shop or, alternatively can indicate that a website is a fake e-shop. In such an example, in applying the blocklist rules, the processor can check if indicators in the requested website are related to, or are likely to be next to, each other. As another example, one blocklist rule can be that websites that contain indicators in proper context are less likely to be a fake e-shop. In such instances, the processor can employ natural language processing (NLP) to analyze a website contextually.

In some embodiments, the centralized server 104 can be configured to send a response (e.g., website filter determination) to the proxy server 124. Based on the response, the proxy server 124 can be permitted or restricted from accessing the requested website. That is, in some embodiments, the centralized server 104 can be configured to determine that the website is a fake e-shop if determined indicator(s) of the website match at least one indicator in the website/indicator blocklist 142 and to determine that the website is not a fake e-shop if a determined indicator(s) of the website does not match at least one indicator in the website/indicator blocklist and is predicted to not be a fake e-shop.

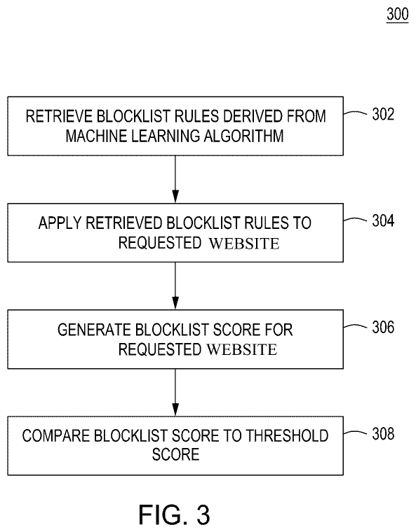

FIG. 3 depicts a flow diagram of a method 300 for fake e-shop detection, in accordance with an alternate embodiment of the present principles. The method 300 can begin at 302 during which a request for a website can be received. For example and as described above, in some embodiments, the centralized server 104 can receive a website request from the user device 102 through the communication network 108. The method 300 can proceed to 304.

At 304, HTML content of the requested website is loaded. The method 300 can proceed to 306.

At 306, website indicators are extracted from the loaded HTML content. As depicted in FIG. 3 and as described above, in some embodiments website indicators can include External indicators 306₁, HTML indicators 306₂, and LLM indicators 306₃. The method 300 can proceed to 308.

At 308, Feature Engineering is performed on the extracted website indicators. As depicted in FIG. 3 and as described above, in some embodiments the Feature Engineering can include a Handling missing values (HMV) process 308₁ and a Feature conversion and aggregation (FCA) process 308₂. The method 300 can proceed to 310 and/or 312.

At 310, at least one of the requested website and/or the engineered, extracted website indicators are compared to at least one of websites and website indicators in a blocklist, that have been previously identified as being associated with at least one fake e-shop, to predict if a resource of the website is associated with a fake e-shop. The method 300 can proceed to 311.

At 311, if a match is not found between at least one of the requested website and/or the engineered, extracted website indicators and at least one of websites and website indicators in the blocklist, the method can proceed to 312. If a match is found between at least one of the requested website and/or the engineered, extracted website indicators and at least one of websites and/or website indicators in the blocklist, the method can proceed to 314.

At 312, a machine learning model, in some embodiments including blocklist rules, is applied to the engineered, extracted website indicators to predict if the requested website, associated with the engineered, extracted website indicators, is a fake e-shop. The method 300 can then proceed to 313.

At 313, if the requested website is identified as a fake e-shop, the method 300 can proceed to 314. If the requested website is not identified as a fake e-shop, the method 300 can proceed to 316.

At 314, at least one of, a message is communicated to a user that requested the website identifying the website as a fake e-shop, access to the requested website is blocked, and/or an identification of the requested website and/or the indicators used to determine that the requested website is a fake e-shop are added to a blocklist of fake e-shop websites and fake e-shop indicators. That is, in some embodiments and as described above, at least one of the blocklists 142 and the optional blocklist 122 on the user device 102 can be updated with the added indicators and/or websites indicative of the fake e-shop. The method 300 can end at 318.

At 316, at least one of, a user that requested the website is given access to the requested website, or an identification of the requested website and/or the indicators used to determine that the requested website is not a fake e-shop are added to a list of safe websites. The method 300 can end at 318.

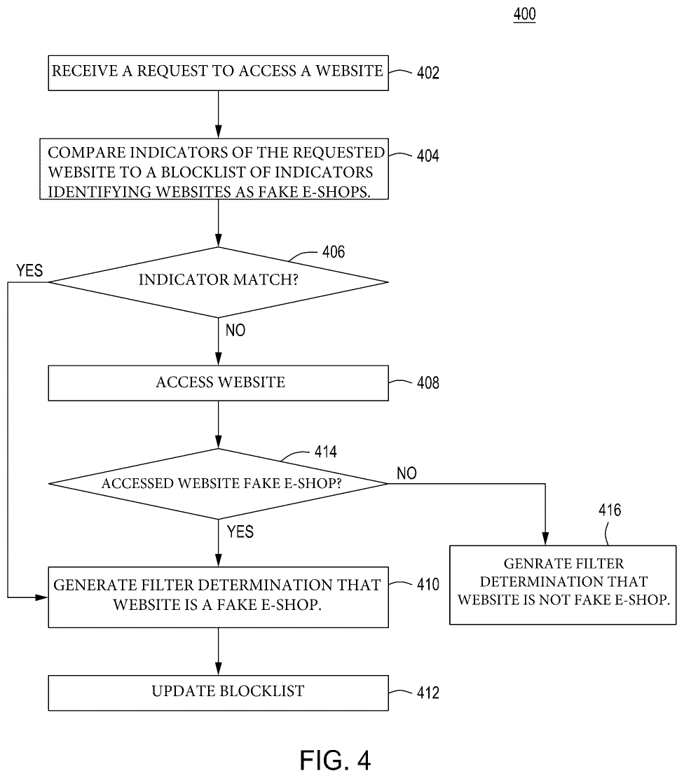

FIG. 4 depicts a flow diagram of an example of a sub-process 400 of step 312 of predicting whether the requested website is a fake e-shop. The sub-process 400 can begin at step 402 by retrieving blocklist rules derived from a machine learning algorithm. The sub-process 400 can also include a step 404 of applying the retrieved blocklist rules to the requested website. The sub-process can also include a step 406 of generating a score based on the blocklist rules. The sub-process 400 can include a step 408 of comparing the determined score to a settable threshold to determine whether or not the website is a fake e-shop. For example, in some embodiments, if the score is at or above the threshold, the requested website may be determined to be a fake e-shop, while a score below the threshold may indicate that the website is not a fake e-shop. In other embodiments, two thresholds—a lower and an upper—can be used. For example, if the score is below the lower threshold, the website can be determined as not being a fake e-shop, while if the score is above the upper threshold, the website can be determined as being a fake e-shop. Moreover, if the score is between the upper and lower thresholds, the website can be determined as potentially a fake e-shop (some similar websites to the requested website were fake e-shops (were associated with fake e-shops), and some similar websites to requested one were not fake e-shops (were not associated with fake e-shops)).

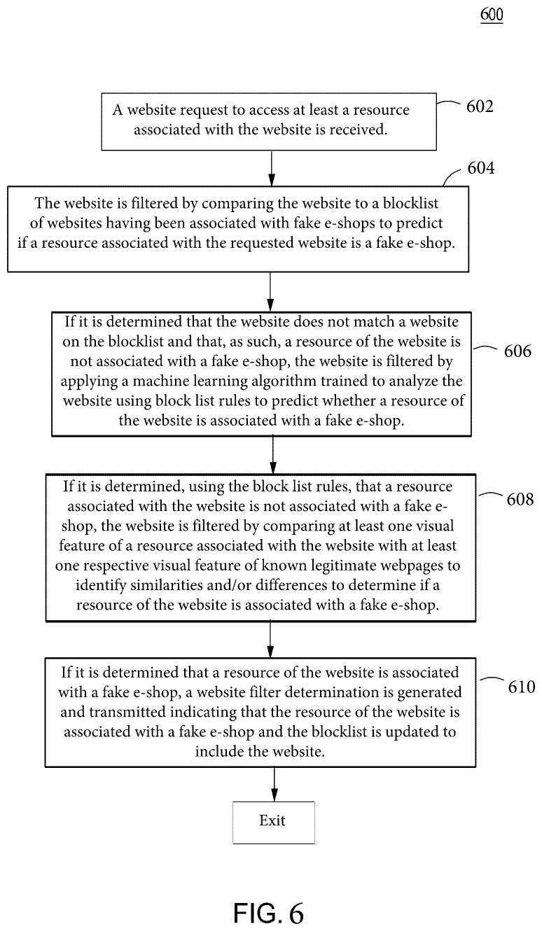

FIG. 6 depicts a flow diagram of an alternate method 600 for efficient filtering of websites in accordance with at least one embodiment of the present principles. The process 600 of FIG. 6 can begin at step 602 by receiving a website request from the proxy server 124 through the communication network 106. The method 600 can proceed to 604 during which the requested website and/or website indicators are compared to a blocklist 142 of websites and indicators identifying websites as fake e-shops. The method 600 can additionally include at 606 determining whether or not the requested website and/or website indicators match a website or indicators on the blocklist 142. If the accessed website and/or indicators match a website and/or indicators on the blocklist 142 (Yes at 606), the method 600 generates a website filter determination at 610 that the requested website is a fake e-shop and updates and stores the blocklist 142 at 612. If the requested website and/or website indicators do not match a website and/or website indicators on the blocklist 142 (No at 606), the method 600 accesses the requested website (e.g., using the web crawler 146) at 606 to determine whether the accessed website is a fake e-shop. The method 600 can also include at 614 determining whether the accessed website is a fake e-shop, for example, by using a machine learning model. If the accessed website is a fake e-shop (Yes at 614), the method generates at 610 the website filter determination that the website is a fake e-shop and updates and stores the blocklist at 612. Otherwise, if the accessed website is not a fake e-shop (No at 614), then the method 600 can generate at 616 a website filter determination that the requested website is not a fake e-shop. The website filter determinations can be sent to the proxy server 124 via communication 126 to be communicated to a user device.

However, evading detection by malicious website filtering systems becomes possible through gradual alterations to existing properties of websites, such as domain names of, for example, websites containing fake e-shop content. In such instances, by changing existing properties, the websites associated with fake e-shops may no longer be identified as fake e-shops, in some embodiments, allowing a user device to access fake e-shops.

As such, in some embodiments, website filtering systems can be fortified by implementing a multi-layered filtering system to enhance security measures against evolving cyber threats, such as fake e-shop websites. In some embodiments, above-described filtering systems can be fortified by adding an additional layer including a machine learning model that conducts filtering predictions, in some embodiments primarily focusing on the most prevalent undesirable fake e-shop websites. In instances in which the requested website is similar to an entry on the blocklist, the user's device promptly issues a notification alerting users of potentially fake content based on the similarity and can subsequently restrict access to the website.

For example, in some embodiments, in addition to the Filtering system of the present principles illustrated by the system 100 of FIG. 1, which can include filtering websites by applying a machine learning algorithm to analyze the website indicators to predict whether the website is a fake e-shop and, alternatively or in addition, can include filtering websites by comparing the website and website indicators to a blocklist of websites and indicators of websites of fake e-shops, in some embodiments, a Filtering system of the present principles, such as the system 100 of FIG. 1, can include identification by the website verification module 140 of fake e-shops by comparing visual features of requested websites with visual features of predefined known websites (i.e., both legitimate and illegitimate).

For example, in some embodiments, a screenshot of at least a portion of respective pages of a target list of legitimate websites can be captured and stored. Alternatively or in addition, a generated description of the visual features of at least a portion of respective pages of a target list of legitimate websites can be stored. Subsequently, when a request for a website is received, visual features of the webpage associated with the requested for a website can be compared with visual features of the stored screenshots and/or the description of the visual features of the legitimate/target website by, for example the website verification module 140, to determine if the requested website is legitimate or not based on the comparison. For example, if the comparison reveals that the visual features of a webpage associated with the requested website are different than the visual features of at least one legitimate website, the website associated with the request can be identified as a fake e-shop and/or possibly a fake e-shop. Alternatively or in addition, if the comparison reveals that the visual features of the webpage associated with the requested website are similar to the visual features of at least one legitimate webpage of a requested website, the website associated with the request can be identified as legitimate.

Alternatively or in addition, some embodiments of a system of the present principles can include a machine learning system/algorithm, such as the machine learning module 144 of the website verification module 140, to train a machine learning model that can be used to identify if visual features of a webpage associated with a requested website matches, for example, visual features of a screenshot of a legitimate/target webpage and/or the description of the visual features of a legitimate/target webpage in accordance with the present principles. As such, a system of the present principles, such as the system 100 of FIG. 1, can identify websites associated with unknown websites (i.e., websites not listed in a blocklist or in some embodiments a clean-list) as fake e-shops or as clean websites (i.e., webpage associated with a target/reference websites).

As an example, a Filtering process of the present principles can include creating and/or receiving a reference list (target list) of location-based commonly targeted brands like PayPal, Amazon, Facebook, and Google. Visual elements of webpages of the targeted brands, such as website screenshots, logos, and/or a description of visual elements, can then be collected to form a database that, in some embodiments, can be used to train one or more ML models to recognize the respective visual elements/brands. Subsequently, for webpages and/or website requests received, respective visual elements of the requested webpages of the websites can be compared to visual elements of the targeted brand webpages to determine if a requested webpage(s)/website(s) belong to the targeted brands based on the comparison in accordance with the present principles.

In some embodiments of the present principles, a threshold can exist/be set by a user and applied by, for example the Website verification module 140, such that if an amount of similarities between the visual elements of the requested website(s) and the visual elements of the targeted brands (i.e., webpages of the targeted brands) exceed the threshold, the requested websites can be identified as websites associated with the targeted brands, and if an amount of similarities between the visual elements of the requested webpage(s)/websites and the visual elements of the targeted brands (i.e., webpages of the targeted brands) are below the threshold, the requested webpages/websites can be identified as possible fake e-shops. Such information can be communicated to a user and/or can be used by a computing system/device of the present principles to control access to the requested webpages/websites in accordance with the present principles.

Alternatively or in addition, in some embodiments, instead of identifying similarities between the visual elements of the requested website(s) and the visual elements of the targeted brands, a system of the present principles can identify differences between the visual elements of the requested website(s) and the visual elements of the targeted brands. In such embodiments, if an amount of differences between the visual elements of the requested website(s) and the visual elements of the targeted brands (i.e., webpages of the targeted brands) are below the threshold, the requested websites can be identified as websites associated with the targeted brands, and if an amount of differences between the visual elements of the requested website(s) and the visual elements of the targeted brands (i.e., webpages of the targeted brands) exceed the threshold, the requested websites can be identified as possible fake e-shops.

In accordance with the present principles, in some embodiments, if it is determined that a resource associated with the website is associated with a fake e-shop, a Website filter determination is generated and transmitted indicating that the resource associated with the website is a fake e-shop and the blocklist is updated to include the website. Such determination can be communicated to a user device.

In embodiments of the present principles, the similarities and differences of the webpages/visual features described herein can include, but are not limited to, similarities and differences in content, content type, methods and/or applications used for creating content, and the like.

In some embodiments, a system of the present principles can include a list (e.g., a whitelist) identifying websites/webpages of, for example, targeted brand that are acceptable for being received (i.e., not fake). In such embodiments, incoming/requested websites/webpages can be compared against a whitelist to remove such acceptable websites/webpages from the filtering process such that only unknown websites/webpages are analyzed in accordance with the present principles.

FIG. 7 depicts a flow diagram of a method 700 for website filtering in accordance with an embodiment of the present principles. The method 700 can begin at 702 during which a website request to access a resource associated with the website is received. The method 700 can proceed to 704.

At 704, the website is filtered by comparing the website to a blocklist of websites having been associated with fake e-shops to predict if a resource associated with the requested website is a fake e-shop. The method 700 can proceed to 706.

At 706, if it is determined that the website does not match a website on the blocklist and that, as such, a resource of the website is not associated with a fake e-shop, the website is filtered by applying a machine learning algorithm trained to analyze the website using block list rules to predict whether a resource of the website is associated with a fake e-shop. The method 700 can proceed to 708.

At 708, if it is determined, using the block list rules, that a resource associated with the website is not associated with a fake e-shop, the website is filtered by comparing at least one visual feature of a resource associated with the website with at least one respective visual feature of known legitimate webpages to identify similarities and/or differences to determine if a resource of the website is associated with a fake e-shop. The method 700 can proceed to 710.

At 710, if it is determined that a resource of the website is associated with a fake e-shop, a website filter determination is generated and transmitted indicating that the resource of the website is associated with a fake e-shop and the blocklist is updated to include the website. The method 700 can then be exited.

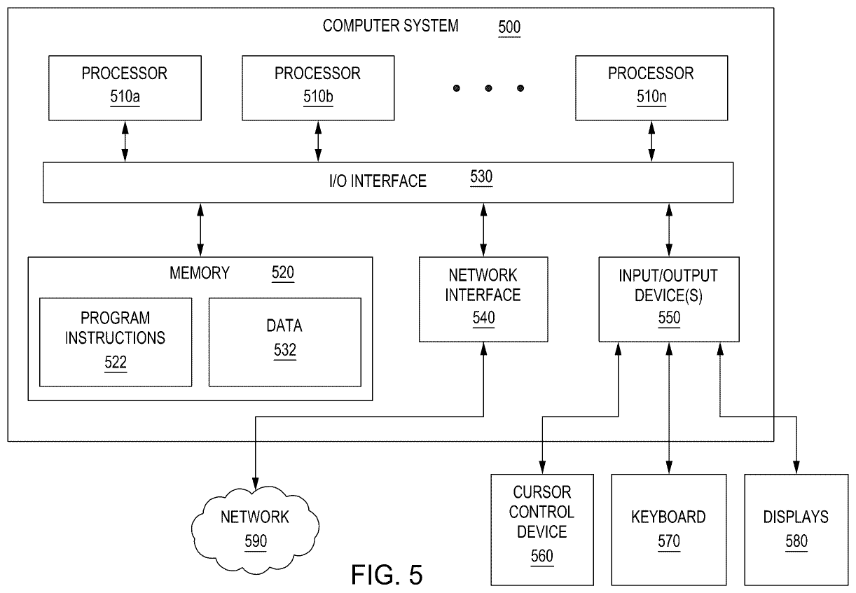

FIG. 5 depicts a computer system 500 that can be utilized to implement the various embodiments of the present principles in accordance with at least one embodiment. That is, FIG. 5 depicts a computer system 500 that can be utilized in various embodiments of the present principles to implement the computer and/or the display, according to one or more embodiments.

Various embodiments of method and system for filtering websites, as described herein, can be executed on one or more computer systems, which may interact with various other devices. One such computer system is computer system 500 illustrated by FIG. 5, which may in various embodiments implement any of the elements or functionality of the present principles. In various embodiments, computer system 500 can be configured to implement methods described above. The computer system 500 can be used to implement any other system, device, element, functionality or method of the above-described embodiments. In the illustrated embodiments, computer system 500 may be configured to implement the methods 200, 300, 400, 600 and 700 as processor-executable executable program instructions 522 (e.g., program instructions executable by processor(s) 510) in various embodiments.

In the illustrated embodiment, computer system 500 includes one or more processors 510a-510n coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of the components may be utilized by the system to receive user input described above. In various embodiments, a user interface may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In alternate embodiments, computer system 500 may be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 can be a uniprocessor system including one processor 510, or a multiprocessor system including several processors 510 (e.g., two, four, eight, or another suitable number). Processors 510 may be any suitable processor capable of executing instructions. For example, in various embodiments processors 510 can be general-purpose or embedded processors implementing any of a variety of instruction set architectures (ISAs). In multiprocessor systems, each of processors 510 can commonly, but not necessarily, implement the same ISA.

System memory 520 can be configured to store program instructions 522 and/or data 532 accessible by processor 510. In various embodiments, system memory 520 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 520. In other embodiments, program instructions and/or data can be received, sent or stored upon different types of computer-accessible media or on similar media separate from system memory 520 or computer system 500.

In one embodiment, I/O interface 530 can be configured to coordinate I/O traffic between processor 510, system memory 520, and any peripheral devices in the device, including network interface 540 or other peripheral interfaces, such as input/output devices 550. In some embodiments, I/O interface 530 can perform any necessary protocol, timing or other data transformations to convert data signals from one component (e.g., system memory 520) into a format suitable for use by another component (e.g., processor 510). In some embodiments, I/O interface 530 can include support for devices attached through various types of peripheral buses, such as a variant of the Peripheral Component Interconnect (PCI) bus standard or the Universal Serial Bus (USB) standard, for example. In some embodiments, the function of I/O interface 530 can be split into two or more separate components, such as a north bridge and a south bridge, for example. Also, in some embodiments some or all of the functionality of I/O interface 530, such as an interface to system memory 520, can be incorporated directly into processor 510.

Network interface 540 can be configured to enable data to be exchanged between computer system 500 and other devices attached to a network (e.g., network 590), such as one or more external systems or between nodes of computer system 500. In various embodiments, network 590 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 550 can, in some embodiments, include one or more display terminals, keyboards, keypads, touchpads, scanning devices, voice or optical recognition devices, or any other devices suitable for entering or accessing data by one or more computer systems 500. Multiple input/output devices 550 can be present in computer system 500 or can be distributed on various nodes of computer system 500. In some embodiments, similar input/output devices can be separate from computer system 500 and can interact with one or more nodes of computer system 500 through a wired or wireless connection, such as over network interface 540.

In some embodiments, the illustrated computer system can implement any of the operations and methods described above, such as the methods illustrated by the flowcharts of the present principles. In other embodiments, different elements and data may be included.

Those skilled in the art will appreciate that computer system 500 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. Computer system 500 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components can not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 can be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods can be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory.

Modules, data structures, and the like defined herein are defined as such for ease of discussion and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

What is claimed is:

1. A website filtering system comprising:
a hardware processor; and a memory accessible by the processor, the memory having stored therein at least one of programs or instructions executable by the at least one processor to cause the filtering system to perform operations comprising:
receiving a request to access a resource associated with a website;
loading HTML content of the requested website;
extracting website indicators from the loaded HTML content;
performing feature engineering on the extracted website indicators;
filtering the website by applying a machine learning model trained to analyze the website indicators to predict whether a resource of the website is associated with a fake e-shop; and
if it is determined that a resource of the requested website is associated with a fake e-shop, generating and transmitting a website filter determination that the resource of the website is associated with a fake e-shop.

2. The system according to claim 1, wherein the filtering system further performs:
filtering the website by comparing the, extracted website indicators to a blocklist of website indicators identified as being associated with at least one fake e-shop to predict if a resource of the website is associated with a fake e-shop; and
if it is determined that a resource of the requested website is associated with a fake e-shop, updating the blocklist to include an identification of at least one of the extracted website indicators or the requested website.

3. The system according to claim 2, wherein the extracted website indicators are compared to a blocklist of website indicators to predict if a resource of the website is associated with a fake e-shop according to determined blocklist rules.

4. The system according to claim 3, wherein the blocklist rules are determined from patterns recognized in at least a portion of text of at least one website in the blocklist.

5. The system according to claim 4, wherein the patterns include related words in a website or a context of words in a website.

6. The system according to claim 2, wherein if it is determined that a resource of the website is not associated with a fake e-shop, the filtering system further performs:
filtering the website by comparing at least one visual feature of the resource associated with the website with at least one respective visual feature of a known legitimate website to identify similarities and/or differences to determine if the resource associated with the website is associated with a fake e-shop.

7. The system according to claim 6, further comprising a threshold wherein if an amount of the similarities are below the threshold or an amount of the differences are above the threshold, the resource of the website is determined to be associated with a fake e-shop.

8. The system according to claim 6, further comprising a machine learning model trained to identify similarities and/or differences between the at least one visual feature of a resource of the requested website and the at least one respective visual feature of the known legitimate website to determine if a resource of the website is associated with a fake e-shop.

9. The system according to claim 1, wherein the website indicators comprise patterns identified in previously known fake e-shop websites.

10. The system according to claim 9, wherein the website indicators comprise at least one of external indicators, HTML indicators, or large learning model (LLM)-determined indicators.

11. A website filtering method comprising:
receiving a request to access a resource associated with a website;
loading HTML content of the requested website;
extracting website indicators from the loaded HTML content;
performing feature engineering on the extracted website indicators;
filtering the website by applying a machine learning model trained to analyze the website indicators to predict whether a resource of the website is associated with a fake e-shop; and
if it is determined that a resource of the requested website is associated with a fake e-shop, generating and transmitting a website filter determination that the resource of the website is associated with a fake e-shop.

12. The method according to claim 11, further comprising:
filtering the website by comparing the extracted website indicators to a blocklist of website indicators identified as being associated with at least one fake e-shop to predict if a resource of the website is associated with a fake e-shop; and
if it is determined that a resource of the requested website is associated with a fake e-shop, updating the blocklist to include an identification of at least one of the extracted website indicators or the requested website.

13. The method according to claim 12, comprising:
comparing the website indicators to a blocklist of website indicators to predict if a resource of the website is associated with a fake e-shop according to predetermined blocklist rules.

14. The method according to claim 12, further comprising:
if it is determined that a resource of the website is not associated with a fake e-shop, filtering the website by comparing at least one visual feature of the resource associated with the website with at least one respective visual feature of a known legitimate website to identify similarities and/or differences to determine if the resource associated with the website is associated with a fake e-shop.

15. The method according to claim 14, further comprising identifying similarities and/or differences between the at least one visual feature of a resource of the requested website and the at least one respective visual feature of the known legitimate website using a machine learning model trained to determine if a resource of the website is associated with a fake e-shop.

16. The method according to claim 11, wherein the website indicators comprise patterns identified in previously known fake e-shop websites.

17. The method according to claim 16, wherein the website indicators comprise at least one of external indicators, HTML indicators, or large learning model (LLM)-determined indicators.

18. A non-transitory computer readable medium, which when executed by a processor and a memory, performs a website filtering method comprising:
receiving a request to access a resource associated with a website;
loading HTML content of the requested website;
extracting website indicators from the loaded HTML content;
performing feature engineering on the extracted website indicators;
filtering the website by applying a machine learning model trained to analyze the website indicators to predict whether a resource of the website is associated with a fake e-shop; and
if it is determined that a resource of the requested website is associated with a fake e-shop, generating and transmitting a website filter determination that the resource of the website is associated with a fake e-shop.

19. The non-transitory computer readable medium according to claim 18, wherein the method further comprises:
filtering the website by comparing the extracted website indicators to a blocklist of website indicators identified as being associated with at least one fake e-shop to predict if a resource of the website is associated with a fake e-shop; and
if it is determined that a resource of the requested website is associated with a fake e-shop, updating the blocklist to include an identification of at least one of the extracted website indicators or the requested website.

20. The non-transitory computer readable medium according to claim 19, comprising:
comparing the extracted website indicators to a blocklist of website indicators to predict if a resource of the website is associated with a fake e-shop according to predetermined blocklist rules.

21. The non-transitory computer readable medium according to claim 20, wherein the blocklist rules are determined from patterns recognized in at least a portion of text of at least one website in the blocklist.

22. The non-transitory computer readable medium according to claim 21, wherein the patterns include related words in a website or a context of words in a website.

23. The non-transitory computer readable medium according to claim 19, further comprising:
if it is determined that a resource of the website is not associated with a fake e-shop, filtering the website by comparing at least one visual feature of the resource associated with the website with at least one respective visual feature of a known legitimate website to identify similarities and/or differences to determine if the resource associated with the website is associated with a fake e-shop.

24. The non-transitory computer readable medium according to claim 23, further comprising identifying similarities and/or differences between the at least one visual feature of a resource of the requested website and the at least one respective visual feature of the known legitimate website using a machine learning model trained to determine if a resource of the website is associated with a fake e-shop.

25. The non-transitory computer readable medium according to claim 18, wherein the website indicators comprise patterns identified in previously known fake e-shop websites.

26. The non-transitory computer readable medium according to claim 25, wherein the website indicators comprise at least one of external indicators, HTML indicators, or large learning model (LLM)-determined indicators.
